(19) United States
(12) Patent Application Publication
(10) Pub. No.: US 2008/0010652 A1
(43) Pub. Date: Jan. 10, 2008

(54) Association of Network Terminals to a Common Account

(75) Inventor: Robert C. Booth, Ivyland, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/616,946

(22) Filed: Dec. 28, 2006

Related U.S. Application Data
(60) Provisional application No. 60/819,529, filed on Jul. 7, 2006.

(51) Int. Cl. H04N 7/16

(52) U.S. Cl. 725/1; 725/139; 725/142

(57) ABSTRACT

An arrangement is disclosed for providing an account identifier from a billing system to a controller that is disposed at the headend of a wide area network (“WAN”) that supports a media content distribution service. In illustrative examples, the WAN is a broadband network to which one or more terminal devices such as STBs are coupled. The billing generates a unique household handle (“HHH”), to identify a particular set of STBs that are associated with a subscriber to the service, which is transmitted to the controller. The controller uses the HHH to prepare a terminal association identifier (“TAI”) that is distributed to the associated STBs. An application programming interface (“API”) resident on each STB is arranged to accept input parameters from one or more applications that run on the STB. The input parameter is typically concatenated with the stored TAI and input to a hashing algorithm. The resultant hashed value is returned to an application and is usable as password to secure a local area network to which the STBs are coupled.

### STATEMENT OF RELATED APPLICATION

This application claims the benefit of provisional application number 60/819,529 filed Jul. 7, 2006, the disclosure of which is incorporated by reference herein.

### BACKGROUND

Digital video recorders (“DVRs”) have become increasingly popular for the flexibility and capabilities offered to users in selecting and then recording video content such as that provided by cable and satellite television service companies. DVRs are consumer electronics devices that record or save television shows, movies, music, and pictures, for example, (collectively “multimedia”) to a hard disk in digital format. Since being introduced in the late 1990s, DVRs have steadily developed additional features and capabilities, such as the ability to record high definition television (“HDTV”) programming. DVRs are sometimes referred to as personal video recorders (“PVRs”).

DVRs allow the “time shifting” feature (traditionally enabled by a video cassette recorder or “VCR” where programming is recorded for later viewing) to be performed more conveniently, and also allow for special recording capabilities such as pausing live TV, fast forward and fast backward, instant replay of interesting scenes, and skipping advertising and commercials.

DVRs were first marketed as standalone consumer electronic devices. Currently, many satellite and cable service providers are incorporating DVR functionality directly into their set-top-boxes (“STBs”). As consumers become more aware of the flexibility and features offered by DVRs, they tend to consume more multimedia content. Thus, service providers often view DVR uptake by their customers as being desirable to support the sale of profitable services such as video on demand (VOD) and pay-per-view (PPV) programming.

Once consumers begin using a DVR, the features and functionalities it provides are generally desired throughout the home. To meet this desire, networked DVR functionality has been developed which entails enabling a DVR to be accessed from multiple rooms in a home over a network. Such home networks often employ a single, large capacity DVR that is placed near the main television in the home. A series of smaller companion terminals, which are connected to other televisions, access the networked DVR over the typically existing coaxial cable in the home. These companion terminals enable users to see the DVR output, and to use the full range of DVR controls (pause, rewind and fast-forward among them) on the remotely located televisions. In some instances, it is possible, for example, to watch one recorded DVR movie in the office while somebody else is watching a different DVR movie in the family room.

The home network must be secured so that the content stream from the DVR is not unintendedly viewed should it leak back through the commonly shared outside coaxial cable plant to a neighboring home or adjacent subscriber in a multiple dwelling unit (“MDU”) such as an apartment building. In some implementations of home networking, a low pass filter is installed at the entry point of the cable to the home to provide radio frequency (“RF”) isolation. In other implementations, a personal identification number (“PIN”) is installed at each terminal in the home network that enables the media content from the DVR to be securely shared. Terminals that do not have the correct PIN are not able to access the network or share the stored content on the networked DVR.

While networked DVRs meet the needs of the market very well, the installation of the low pass filter or the provisioning of the necessary PIN to each terminal can be a potentially time consuming and expensive process for the service provider. Truck roll costs must be borne if an installer must go to the home to manually set the PIN or install the low pass filter. If self-installation of the PIN by the consumer is more preferable, resources must be expended to develop and then support a PIN installation interface that can be successfully utilized by the consumer. In instances where the terminal is pre-provisioned with the PIN, logistical, inventory, and supply issues can add to costs. For example, the service provider must either develop tools to set the PIN when the devices are offline at a warehouse or otherwise have personnel set the PIN manually. In addition, the service provider must develop and maintain facilities to manage and track PINs for additional terminals that are needed to accommodate growth of a consumer's home network.

### DESCRIPTION OF THE DRAWINGS

FIG. 1 is a pictorial representation of an illustrative home network having a plurality of terminal devices that are coupled to several broadband multimedia sources;

FIG. 2 is a block diagram of an illustrative multimedia delivery network having a network headend, hubs coupled to the headend, and nodes coupled to the hubs, where the nodes each provide broadband multimedia services to a plurality of homes;

FIG. 3 is a pictorial representation of an illustrative multiple dwelling unit having a number of apartments, each with a plurality of terminal devices, where the apartments share common infrastructure to receive broadband multimedia services;

FIG. 4 is a simplified block diagram of an illustrative wide area network and a local area network which share a common portion of physical infrastructure;

FIG. 5 is a simplified functional block diagram of an illustrative local area network having a plurality of terminal devices that are also coupled to a wide area network;

FIG. 6 is a pictorial illustration of graphical user interfaces displayed on a home multimedia server and client set top box;

FIG. 7 is a simplified functional block diagram showing an illustrative network headend coupled over a wide area network to the household of a subscriber;

FIG. 8 is a simplified block diagram of an architecture for an illustrative set top box;

FIG. 9 is a flowchart of an illustrative method for generating and distributing a household handle and terminal association identifier;

FIG. 10 is a flowchart of an illustrative method for using a terminal association identifier at a set top box; and

FIG. 11 is a diagram showing an illustrative shared-key authentication message flow between terminals over a local area network

### DETAILED DESCRIPTION

An arrangement is disclosed for providing an account identifier from a billing system to a controller that is disposed at the headend of a wide area network (“WAN”) that supports a media content distribution service. In illustrative examples, the WAN is a broadband network which is selected from a cable network, telecommunications network or direct satellite broadcast (“DBS”) network to which one or more terminal devices such as STBs are coupled. The billing system generates a unique household handle (“HHH”) to identify a particular set of STBs that are associated with an account of a subscriber to the service. The HHH is transmitted to the controller which uses it to prepare a terminal association identifier (“TAI”) that is distributed to the set of associated STBs which, in turn, store the received TAI in nonvolatile memory. The TAI is optionally prepared by inputting the HHH received from the billing system into a hashing algorithm. The controller uses the unique HHH to generate the TAI which is in a data format and provided over a transport protocol that is usable by the set of associated STBs to which the controller has direct access over the media content distribution system.

An application programming interface (“API”), instantiated on each STB in the set of associated STBs, is arranged to accept input parameters from one or more applications that run on the STB. The input parameter is typically concatenated with the stored TAI and input to a hashing algorithm. The resultant hashed value is returned to the application.

In an illustrative example, one such STB application is arranged to generate a PIN from the returned hash value that is commonly utilized by each associated STB to form a secure local area network (“LAN”). That is, each of the associated STBs recreates the commonly utilized PIN using the API and the stored TAI. STBs seeking to access the LAN are authenticated with the common PIN. STBs which are not authenticated are denied access to the home LAN thus ensuring, for example, that content stored on a DVR in one STB is not unintendedly consumed by STBs that are not authorized to receive it.

Such arrangement provides a number of advantages. Associating STBs using the HHH and TAI enables the distribution of the commonly utilized PIN to be highly automated while simultaneously increasing the security robustness of the distribution system since each of associated STBs generates the commonly utilized PIN locally. Thus, costs associated with a truck roll service call and the support and maintenance costs attendant to self-installation by the subscriber or warehouse PIN provisioning are reduced or eliminated.

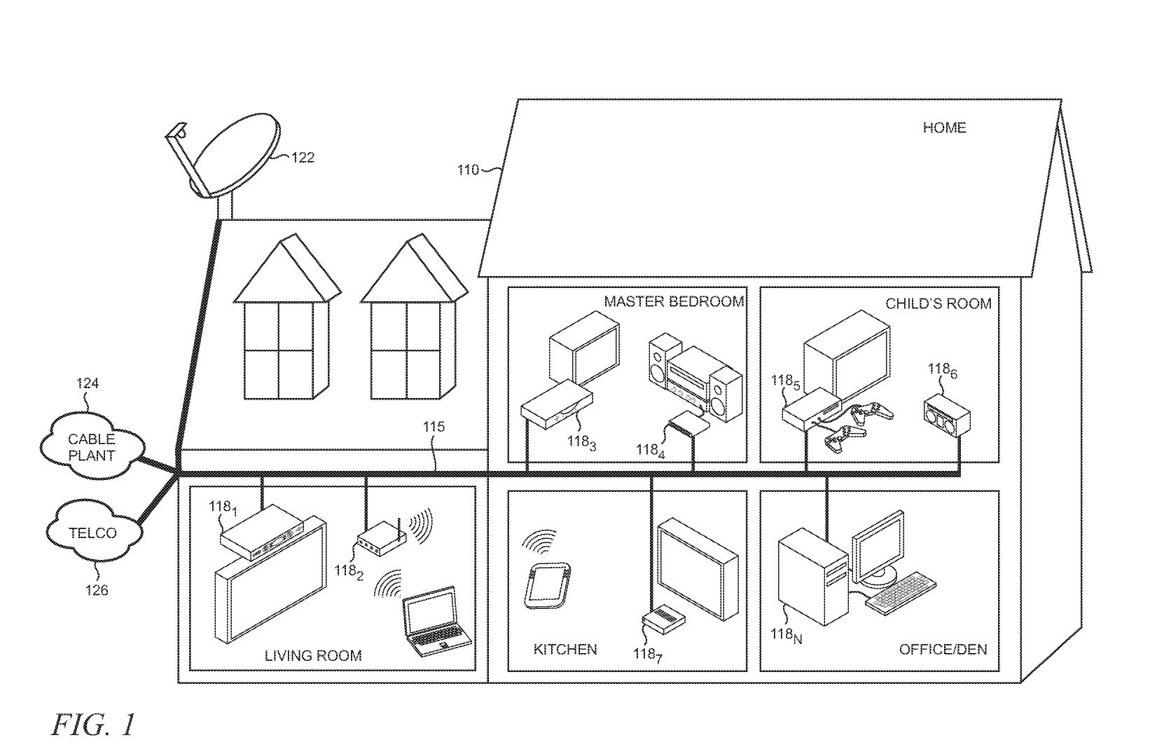

Turning now to FIG. 1, a pictorial representation of an illustrative arrangement is provided which shows a home 110 with infrastructure 115 to which a plurality of illustrative terminal devices 118₁ to 118_{N} are coupled. Connected to the terminal devices 118 are a variety of consumer electronic devices that are arranged to consume multimedia content. For example, terminal device 118₁ is an STB with an integrated networkable DVR which functions as a home network multimedia server, as described in detail below.

Several network sources are coupled to deliver broadband multimedia content to home 110 and are typically configured as WANs. A satellite network source, such as one used in conjunction with a DBS service is indicated by reference numeral 122. A cable plant 124 and a telecommunications network 126, for example, for implementing a digital subscriber line (“DSL”) service, are also coupled to home 110.

In the illustrative arrangement of FIG. 1, infrastructure 115 is implemented using coaxial cable that is run to the various rooms in the house, as shown. Such coaxial cable is commonly used as a distribution medium for the multimedia content provided by network sources 122, 124, and 126. In alternative examples, infrastructure 115 is implemented using telephone or power wiring in the home 110. In accordance with the present arrangement for remotely provisioning a common PIN, infrastructure 115 also supports a home LAN, and more particularly, a home multimedia network.

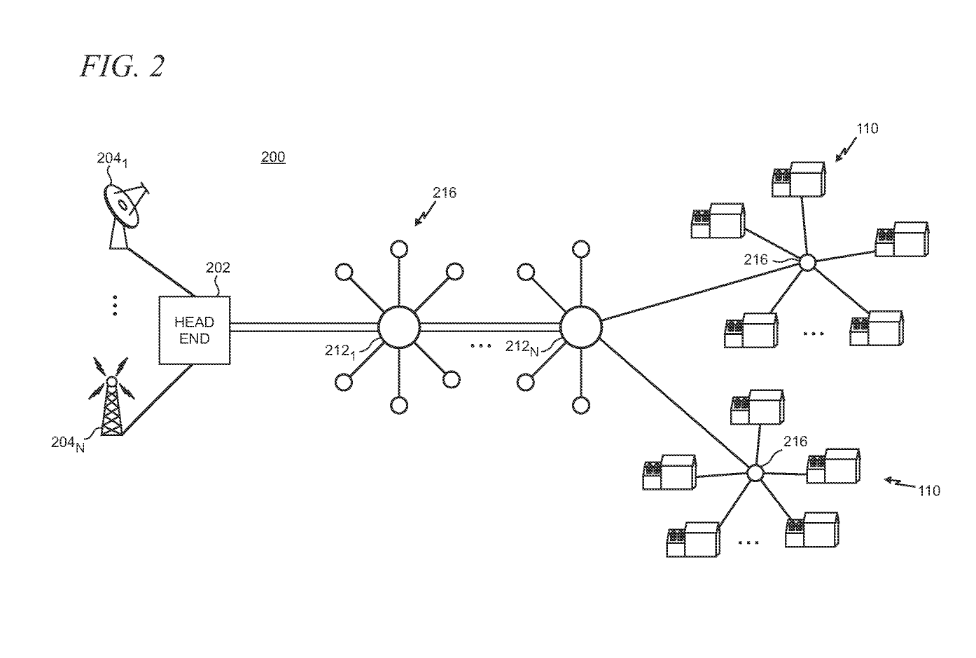

FIG. 2 is a block diagram of an illustrative multimedia delivery network 200 having a network headend 202, hubs 212₁ to 212_{N} coupled to the headend 202, and nodes (collectively indicated by reference numeral 216) coupled to the hubs 212. Nodes 216 each provide broadband multimedia services to a plurality of homes 110, as shown. Multimedia delivery network 200 is, in this example, a cable television network. However, DBS and telecommunication networks are operated with substantially similar functionality.

Headend 202 is coupled to receive programming content from sources 204, typically a plurality of sources, including an antenna tower and satellite dish as in this example. In various alternative applications, programming content is also received using microwave or other feeds including direct fiber links to programming content sources.

Network 200 uses a hybrid fiber/coaxial (“HFC”) cable plant that comprises fiber running among the headend 202 and hubs 212 and coaxial cable arranged as feeders and drops from the nodes 216 to homes 110. Each node 216 typically supports several hundred homes 110 using common coaxial cable infrastructure in a tree and branch configuration. As a result, as noted above, the potential exists for content stored on a networked DVR in one home on a node to be unintendedly viewed by another home on the node unless steps are taken to isolate the portions of the cable plant in each home that are utilized to implement the home multimedia network.

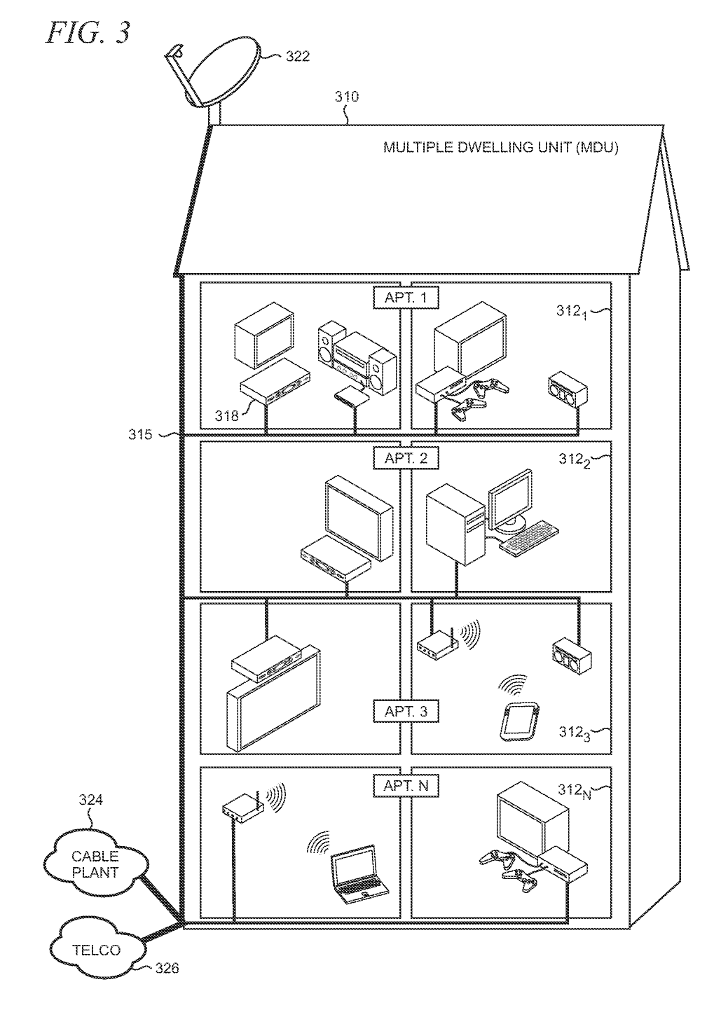

FIG. 3 is a pictorial representation of an illustrative multiple dwelling unit 310 having a number of apartments 312₁ to 312_{N}, each with a plurality of terminal devices coupled to a common coaxial cable infrastructure 315. In a similar manner to that shown in FIG. 1 and described in the accompanying text, MDU 310 receives broadband multimedia services from WANs including a satellite network source 322, cable plant 324, and telecommunications network 326.

Apartments 312 each use respective portions of infrastructure 315 to implement a LAN comprising a home multimedia network. Since apartments 312 share common infrastructure 315, measures must be taken to isolate each home multimedia network in the MDU so that content stored, for example, on a networkable DVR in STB 318 in apartment 1, is not unintendedly viewed in apartment 2 in MDU 310.

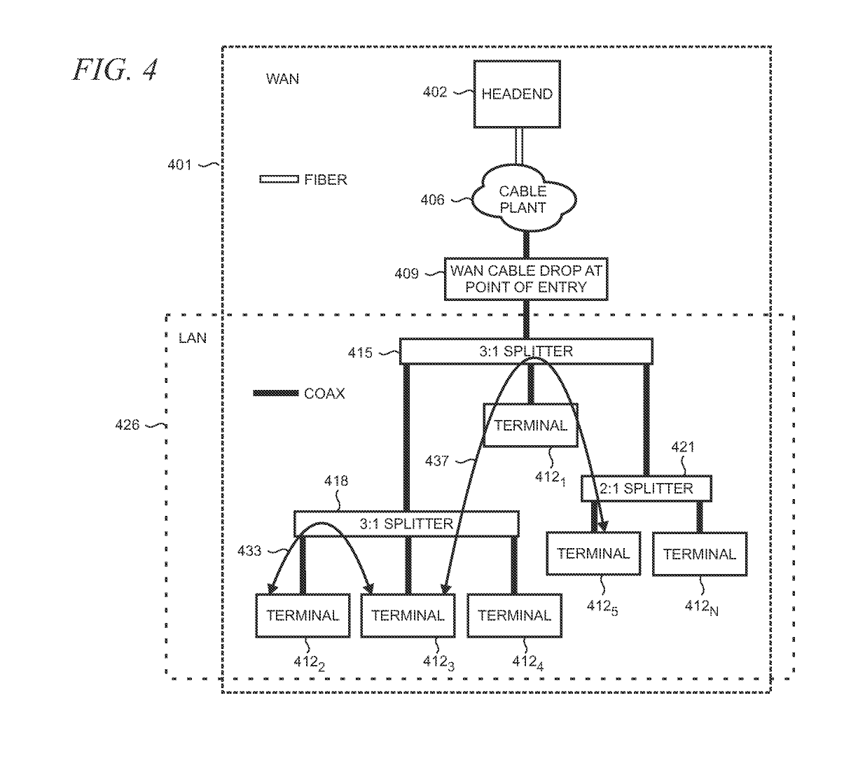

FIG. 4 shows an example of how the wide area and local area networks described above share a common portion of physical infrastructure. A WAN 401, for example a cable television network, includes a headend 402 and cable plant 406. Cable plant 406 is typically arranged as an HFC network having coaxial cable drops at a plurality of terminations at broadband multimedia service subscribers' buildings such as homes, offices, and MDUs. One such cable drop is indicated by reference number 409 in FIG. 4.

From the cable drop 409, WAN 401 is coupled to individual terminals 412₁ to 412_{N} using a plurality of splitters, including 3:1 splitters 415 and 418 and a 2:1 splitter 421 and coaxial cable (indicated by the heavy lines in FIG. 4). It is noted that the number and configuration of splitters shown in FIG. 4 is illustrative and other types and quantities of splitters will vary depending on the number of terminals deployed in a particular application. Headend 402 is thus coupled directly to each of the terminals 412 in the household to enable multimedia content to be streamed to the terminals over the WAN 401. In most applications, terminals 412 and cable plant 406 are arranged with two-way communication capability so that signals which originate at a subscriber's household can be delivered back upstream to the headend. Such capability enables the implementation of a variety of interactive services. It further provides a subscriber with a convenient way to order services from the headend, make queries as to account status, and browse available multimedia choices using an electronic programming guide (“EPG”), for example.

In typical applications WAN 401 operates with multiple channels using RF signals in the range of 50 to as high as 860 Mhz for downstream communications (i.e., from headend to terminal). Upstream communications (i.e., from terminal to headend) have a typical frequency range from 5 to 42 MHz.

LAN 426 commonly shares the portion of networking infrastructure installed at the building with WAN 401. More specifically, as shown in FIG. 4, the coaxial cable and splitters in the building are used to enable inter-terminal communication. This is accomplished using a network or communications interface in each terminal, such as a network interface module (“NIM”), chipset or other circuits, that provides an ability for an RF signal to jump backwards through one or more splitters. Such splitter jumping is illustratively indicated by arrows 433 and 437 in FIG. 4.

In many applications, LAN 426 is arranged with the capability for operating multiple RF channels in the range of 800-1550 MHz, with a typical operating range of 1 to 1.5 GHz. LAN 426 is generally arranged as an IP (Internet protocol) network. Other networks operating at other RF frequencies may optionally use portions of the LAN 426 and WAN 401 infrastructure. For example, a broadband internet access network using a cable modem (not shown), voice over internet protocol (“VOIP”) network, and/or out of band (“OOB”) control signaling and messaging network functionalities are commonly operated on LAN 426 in many applications.

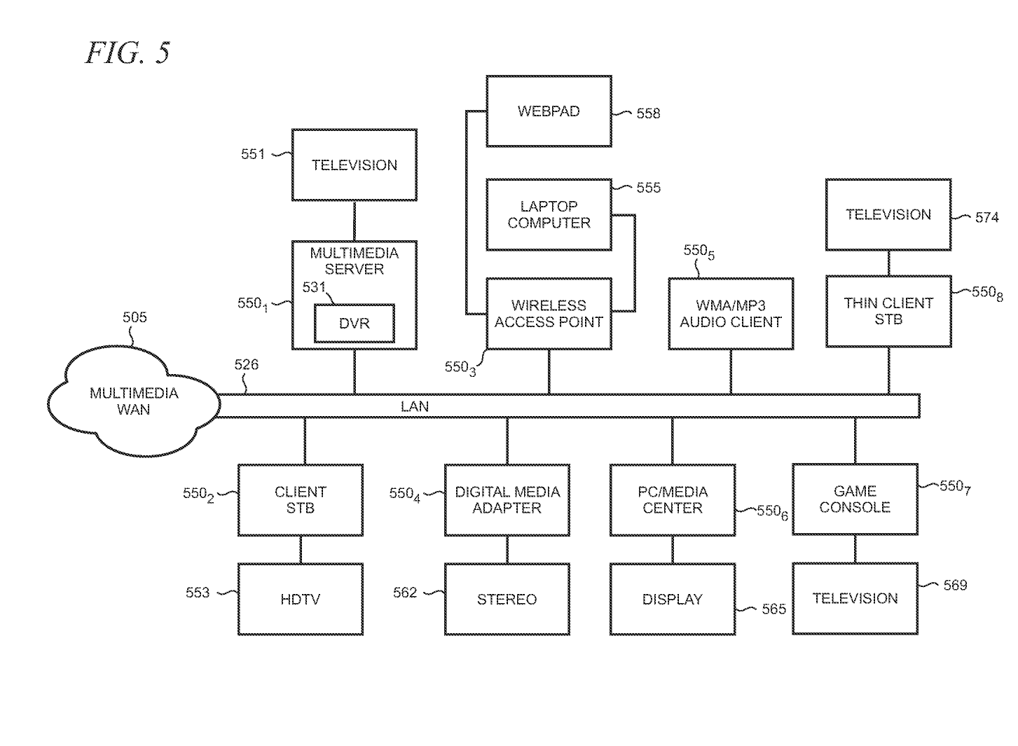

FIG. 5 is a functional block diagram of an illustrative LAN 526, having a plurality of coupled terminal devices 550, that is operated in a multimedia service subscriber's home. As with the arrangement shown in FIG. 4 and described in the accompanying text, the terminal devices coupled to LAN 526 are also coupled to a WAN 505 to receive multimedia content services such as television programming, movies, and music from a service provider. Thus, WAN 505 and LAN 526 share a portion of common networking infrastructure, which in this example is coaxial cable, but operate at different frequencies.

A variety of terminal devices 550₁₋₈ are coupled to LAN 526 in this illustrative example. A multimedia server 550₁ is coupled to LAN 526. Multimedia server 550₁ is arranged using an STB with integrated networkable DVR 531. Alternatively, multimedia server 550₁ is arranged from devices such as personal computers, media jukeboxes, audio/visual file servers, and other devices that can store and serve multimedia content over LAN 526. Multimedia server 550₁ is further coupled to a television 551.

Client STB 550₂ is another example of a terminal that is coupled to LAN 526 and WAN 505. Client STB 550₂ is arranged to receive multimedia content over WAN 505 which is played on the coupled HDTV 553. Client STB 550₂ is also arranged to communicate with other terminals on LAN 526, including for example multimedia server 550, in order to access content stored on the DVR 531. Thus, for example, a high definition PPV movie that is recorded on DVR 531 in multimedia server 550₁, located in the living room of the home, can be watched on the HDTV 553 in the home's family room.

Wireless access point 550₃ allows network services and content from WAN 505 and LAN 526 to be accessed and shared with wireless devices such as laptop computer 555 and webpad 558. Such devices with wireless communications capabilities (implemented, for example, using the Institute of Electrical and Electronics Engineers IEEE 802.11 wireless communications protocols) are commonly used in many home networking applications. Thus, for example, photographs stored on DVR 531 can be accessed on webpad 558 that is located in the kitchen of the home over LAN 526.

Digital media adapter 550₄ allows network services and content from WAN 505 and LAN 526 to be accessed and shared with media players such as home entertainment centers or stereo 562. Digital media adapter 550₄ is typically configured to take content stored and transmitted in a digital format and convert it into an analog signal. For example, a streaming internet radio broadcast received from WAN 505 and recorded on DVR 531 is accessible for play on stereo 562 in the home's master bedroom.

WMA/MP3 audio client 550₅ is an example of a class of devices that can access digital data directly without the use of external digital to analog conversion. WMA/MP3 client 550₅ is a music player that supports the common Windows Media Audio digital file format and/or the Moving Picture Expert Group (“MPEG”) Audio Layer 3 digital file format, for example. WMA/MP3 audio client 550₅ might be located in a child's room in the home to listen to a music channel supplied over WAN 505 or to access an MP3 music library that is stored on DVR 531 using LAN 526.

A personal computer, PC 550₆ (which is optionally arranged as a media center-type PC typically having one or more DVD drives, a large capacity hard disk drive, and high resolution graphics adapter) is coupled to WAN 505 and LAN 526 to access and play streamed or stored media content on coupled display device 565 such as a flat panel monitor. PC 550₆, which for example is located in an office/den in the home, may thus access recorded content, such as a television show, on DVR 53 land watch it on the display device 565. In alternative arrangements, PC 550₆ is used as a multimedia server having similar content sharing functionalities and features as multimedia server 550₁ which is described above.

A game console 550₇ and coupled television 569, as might be found in a child's room, is also coupled to WAN 505 and LAN 526 to receive streaming and stored media content, respectively. Many current game consoles play game content as well as media content such as video and music. Online internet access is also used in many settings to enable multi-player network game sessions.

Thin client STB 550₈ couples a television 574 to WAN 505 and LAN 526. Thin client STB 550₈ is an example of a class of STBs that feature basic functionality, usually enough to handle common EPG and VOD/PPV functions. Such devices tend to have lower powered central processing units and less random access memory than thick client STBs such as multimedia server 550₁ above. Thin client STB 550₈ is, however, configured with sufficient resources to host a user interface that enables a user to browse, select, and play content stored on DVR 531 in multimedia server 550₁. Such user interface is configured, in this illustrative example, using an EPG-like interface that allows remotely stored content to be accessed and controlled just as if content was originated to thin client STB 550₈ from its own integrated DVR. That is, the common DVR programming controls including picking a program from the recorded library, playing it, using fast forward or fast back, and pause are supported by the user interface hosted on thin client STB 550₈ in a transparent manner for the user.

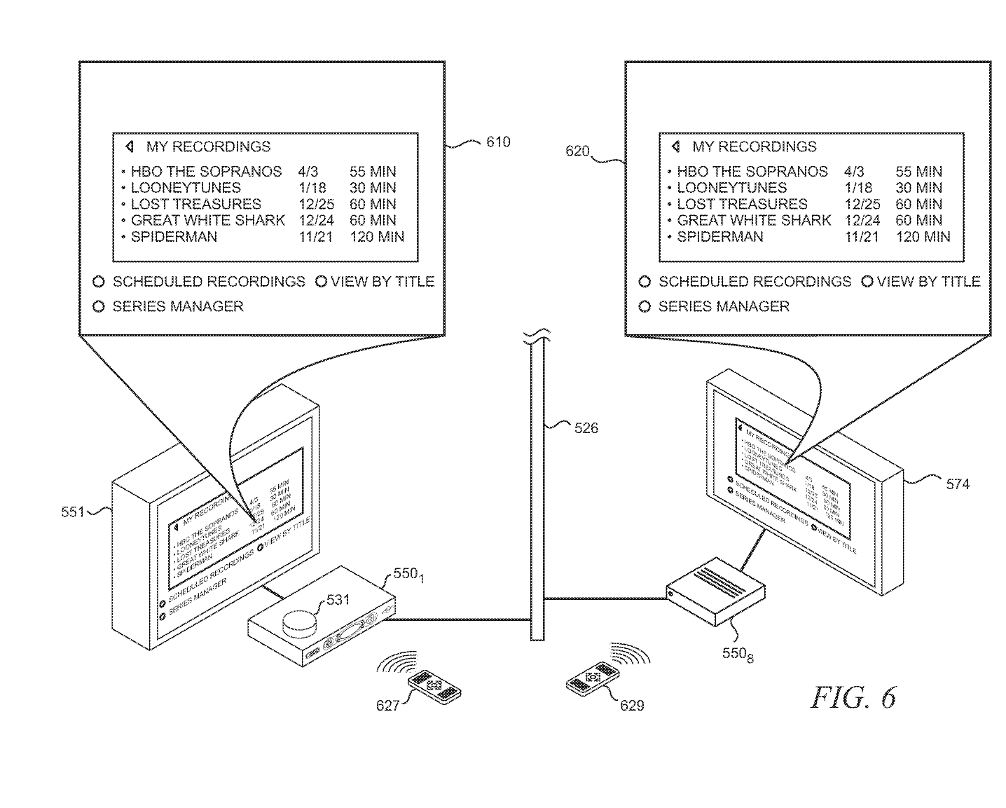

FIG. 6 is a pictorial illustration of the graphical user interfaces displayed on televisions 551 and 574 that are hosted by home multimedia server 550₁ and thin client STB 550₈ respectively, which are coupled to LAN 526 as shown. Graphical user interface (“GUI”) 610 shows the content recorded on DVR 531 including a title, date recorded, and program length. A user typically interacts with GUI 610 using a remote control 627 to make recordings, set preferences, browse and select the content to be consumed.

Thin client STB 550₈ hosts GUI 620 with which the user interacts using remote control 629. As shown, GUI 620 displays the same content and controls as GUI 610. Content selected by the user for consumption on television 574 is shared over LAN 526.

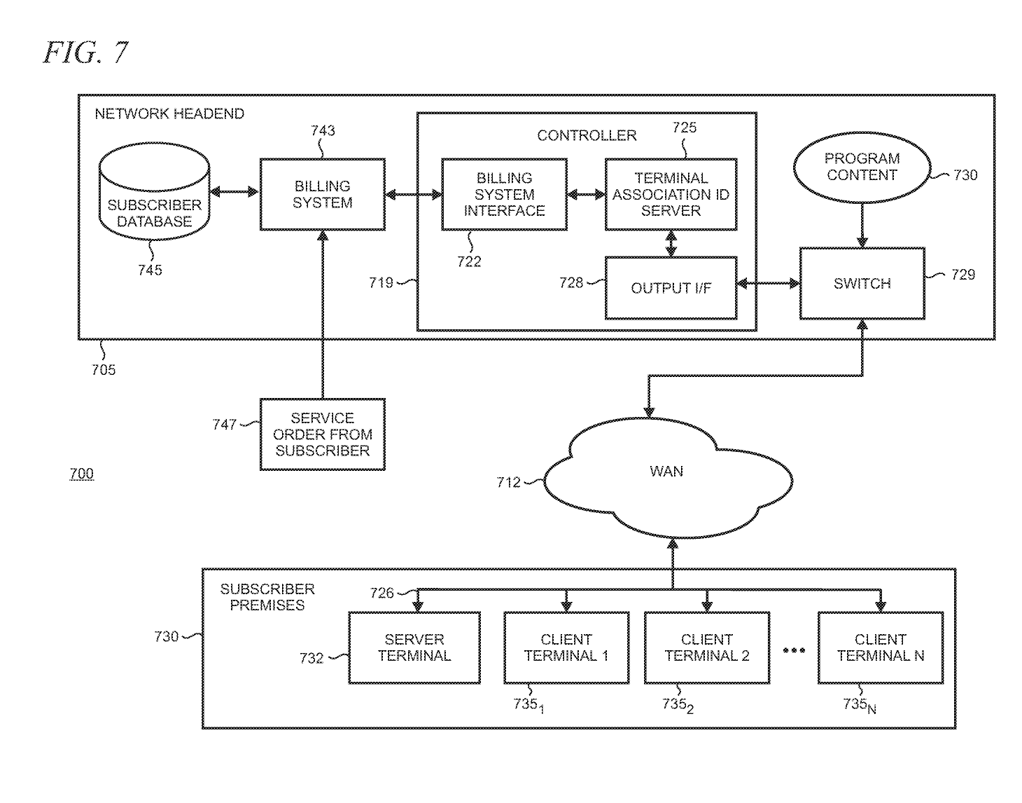

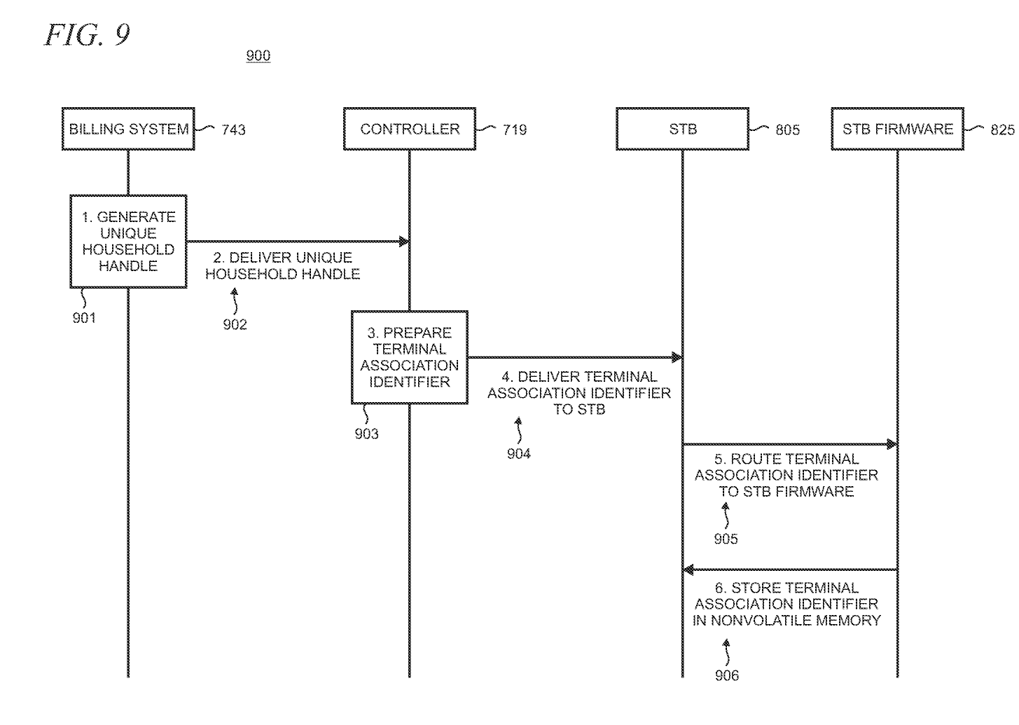

FIG. 7 is functional block diagram showing an illustrative arrangement 700 that includes a network headend 705 that is coupled over a WAN 712 to subscriber household 730. WAN 712 is arranged in a similar manner to WAN 401 shown in FIG. 4 and described in the accompanying text. Network headend 705 includes a controller 719 having a billing system interface 722. A TAI (terminal association ID) server 725 is operatively coupled to the billing system interface 722. In this illustrative example and as described in more detail in the text accompanying FIG. 9, TAI server 725 in controller 719 transmits a TAI using a DCT MSP (Digital Cable Terminal Message Stream Protocol) configuration message sent in the OOB network channel. In other arrangements the TAI may be sent over an IP-type network. TAI server 725 is typically a logical component of controller 719, although it may also be discretely physically embodied in some applications in either hardware, firmware, or software, or a combination thereof

Controller 719 also includes an output interface 728 that is operatively coupled to a switch 729 (that typically includes multiplexer and/or modulator functionality) that modulates programming content 730 from sources 204 (FIG. 2) on to the WAN 712 along with control information, messages, and other data, using the OOB network channel.

A plurality of terminals including a server terminal 732 and client terminals 735₁ to 735_{N} are disposed in subscriber household 730. Server terminal 732 is alternatively arranged with similar features and functions as multimedia server 529 (FIG. 5) or PC/Media Center 559 (FIG. 5). Client terminals 735 are arranged with similar features and functions as client STB 537 or thin client STB 578 (FIG. 5). Server terminal 732 and client terminals 735 are coupled to LAN 726 which is, in this illustrative example, arranged using coaxial cable infrastructure in a similar arrangement as LAN 526 (FIG. 5).

Billing system interface 722 is arranged to receive data from a billing system 743 that is disposed in the network headend 705. Billing system 743 is generally implemented as a computerized, automated billing system that is connected to the outgoing TAI server, among other elements, at the network headend 705. Billing system 743 readily facilitates the various programming and service options and configurations available to subscribers which typically results, for example, in the generation of different monthly billing for each subscriber. Data describing each subscriber, and the programming and service options associated therewith, are stored in a subscriber database 745 that is operatively coupled to the billing system 743.

Service orders from the subscribers are indicated by block 747 in FIG. 7 which are input to the billing system 743. Such orders are generated using a variety of input methods including telephone, internet, or website portals operated by the service provider, or via input that comes from a terminal in subscriber household 730. In this latter case, a user typically interacts with a GUI or EPG that is hosted on one of the terminals 732 and 735.

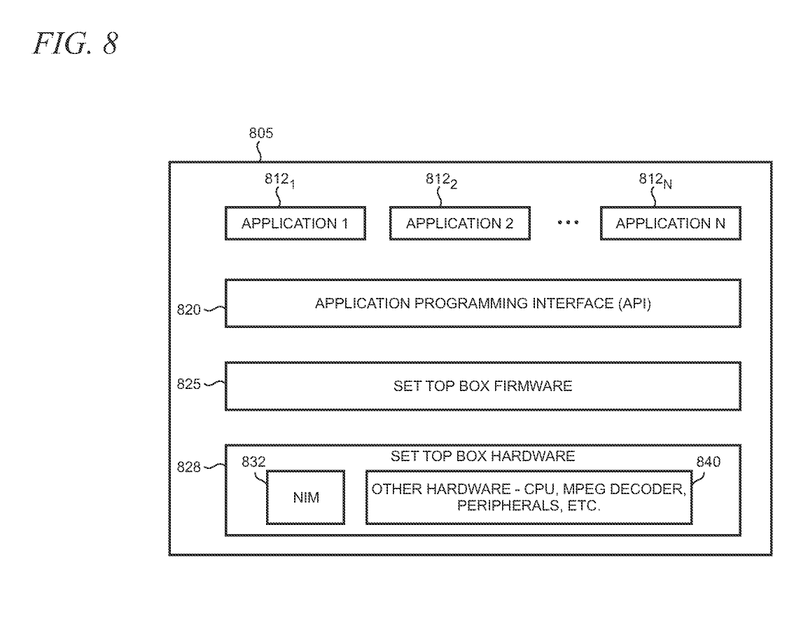

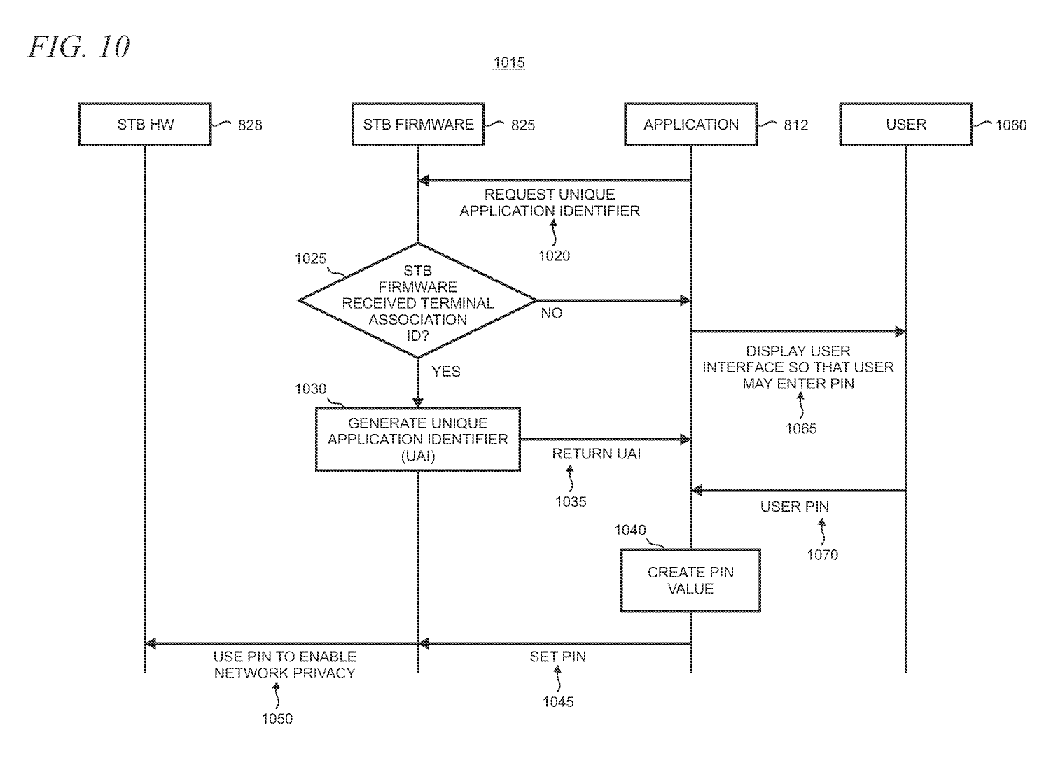

FIG. 8 is a simplified block diagram of an architecture for an illustrative set top box 805. The set top box architecture 805 is typical of terminals located at the subscriber household 730 in FIG. 7 (including server terminal 732 and client terminals 735). Set box architecture 805, in this illustrative example, includes a group of applications 812_{1-N} which is a common configuration in most scenarios. However, in other scenarios, set top box architecture 805 may include a single application. Applications 812 provide a variety of common STB functionalities including, for example, EPG functions, DVR recording, web browsing, email, support for electronic commerce and the like. As described below in the text accompanying FIG. 10, one of the applications 812 is arranged to generate a PIN using the TAI received from the TAI server 725 in controller 719 (FIG. 7).

An API 820 is resident in architecture 805 in a layer between the applications 812 and the STB firmware 825 which functions as an intermediary between these components. Thus, API 820 is used to pass input parameters, requests and/or other information and data between applications 812 and firmware 825. Below the firmware 825 in architecture 805 is a layer of STB hardware 828. Hardware 828 includes a NIM 832 along with other hardware 840 including, for example, interfaces, peripherals, ports, a CPU (central processing unit), MPEG decoder, memory, and various other components that are commonly utilized to provide conventional STB features and functions.

FIG. 9 is a flowchart of an illustrative method 900 for generating and distributing a household handle and terminal association identifier which may be utilized by the arrangement 700 (FIG. 7). The first step 901 includes creating an HHH (household handle) at the billing system 743 that is specific to a set of STBs within a given household that are associated with a billing system account (i.e., service subscriber account). In this illustrative example, the HHH comprises a 20 byte field in the Digital Wirelink Protocol with which the household is uniquely identified. The HHH may be selected from any number, alphanumeric string, character string or combination thereof that can be used to uniquely identify the billing system account and may comprise, for example, a customer account number.

The second step 902 includes delivering the unique HHH from the billing system 743 to the controller 719 using, for example, the Wirelink Protocol. The third step 903 includes preparing the TAI for delivery. Step 903 optionally includes translating the HHH received from the billing system 743 into a different value or format, for example, using a CRC32 (cyclic redundancy check), MD5 (Message Digest 5), or SHA-1 (Secure Hash Algorithm) hashing algorithm.

The fourth step 904 includes delivering the TAI to the STB 805 (although a single STB 805 is shown in FIG. 9, the TAI is normally delivered to all the associated STBs in a household, for example, subscriber household 730). As noted above, the TAI is deliverable to the STB 805 using an OOB DCT MSP configuration message.

The DCT MSP configuration message is embodied with a subcommand ID which supports a terminal association identifier field which is used to carry the TAI. The terminal_association_config subcommand specifies a terminal's association configuration to thereby associate the terminal with other terminals within a service The terminal_assoc_control is a 32-bit value bit-mask type used to control how the terminal association identifier included in the DCT MSP configuration message can be utilized by the receiving terminal. This field is initially a reserved value that is set to a default of 0.The terminal_assoc_identifier is a 160-bit value used to associate a particular terminal with other terminals on the same service subscriber's account.

The fifth step 905 in FIG. 9 includes routing the received TAI from the STB 805 to firmware 825. The sixth step 906 includes storing the TAI by the STB 805 into nonvolatile storage to preserve the TAI value during STB power off and resets.

FIG. 10 is a flowchart of an illustrative method 1015 for using a TAI at an STB 805 (FIG. 8). An application 812 is arranged to generate a PIN that is used to form a secure LAN. The API 820 (FIG. 8) provides access to application 812 to pass an input parameter in the form of a request 1020 to be passed to STB firmware 825 for a unique application identifier. If, at decision block 1025, the STB has received and stored a TAI, then in this illustrative example, the input parameter is concatenated with the TAI that is stored in the STB's nonvolatile memory prior to being passed through a hashing algorithm. The resulting hash value is thus utilized to generate the unique application identifier as shown at block 1030. The unique application identifier is returned to the application 812 as indicated by reference numeral 1035 in FIG. 10. It is noted that the stored TAI is not exposed to any applications in STB 805 (i.e., the stored TAI remains a secret with the STB firmware 825 to ensure security for the generated PIN). For example, in some scenarios, a STB may host applications that are provided by third party sources or sources that are not trusted. Accordingly, maintaining the TAI secretly can provide additional network security. However, in some alternative implementations, such secrecy does not need to be maintained.

At block 1040, application 812 uses the returned hash value to create a PIN value. The PIN value is passed to STB firmware 825 to thereby set the PIN (as indicated by reference numeral 1045) which is used by STB hardware 828 to enable network privacy (as indicated by reference numeral 1050). In alternative examples, applications running on STB 805 may use the returned hash value for other purposes beyond creating a PIN to enable network security, for example, where unique and secure identification or association is required to be recreated at each terminal among a set of terminals in a subscriber household.

If, at decision block 1025, the STB has not been received and stored a TAI, then the application 812 is optionally arranged to display a user interface, as indicated by reference numeral 1065 which prompts a user 1060 to manually enter a PIN value. The User PIN is returned to the application in lieu of the unique application identifier as indicated by reference numeral 1070.

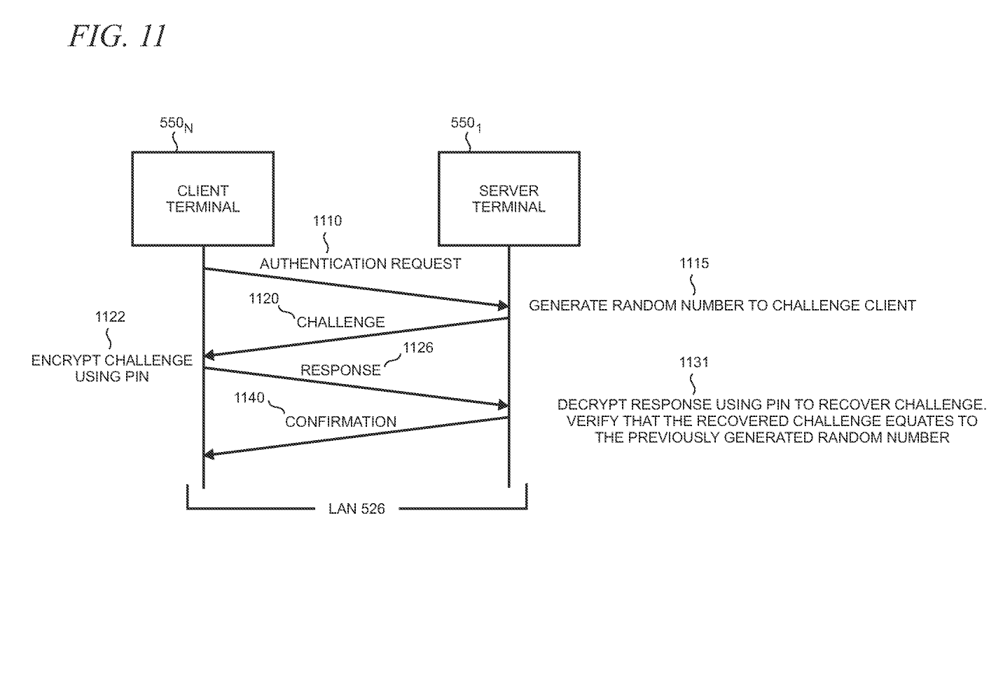

FIG. 11 is a diagram showing an illustrative shared-key authentication message flow between the server terminal 550₁ and one or more of the other terminal devices 550 (hereinafter referred to singly as a client terminal 550_{N}) over LAN 526, that are shown in FIG. 5. Server terminal 550₁ and the client terminal 550_{N} are able to use shared-key authentication after each creates a commonly-utilized PIN as shown in FIGS. 9 and 10 and described in the accompanying text.

In this illustrative example, the messages are conveyed as MAC (media access control) sublayer messages which are transported in the data link layer of the OSI (Open Systems Interconnection) model on the IP network which operates on LAN 926. Client terminal 550_{N} sends an authentication request message 1110 to server terminal 550₁. Client terminal 550_{N} sends the authentication request when looking to join (i.e., gain access to) LAN 526 to thereby consume stored content (such as programming recorded on the DVR disposed in the server terminal). In response to the authentication request, server terminal 550₁ generates a random number as indicated by reference numeral 1115. The random number is used to create a challenge message 1120 which is sent back to client terminal 550_{N}.

As indicated by reference numeral 1122 in FIG. 1, client terminal 550_{N} encrypts the challenge using the commonly-utilized PIN. Client terminal 550_{N} uses any of a variety of known encryption techniques, such as the RC4 stream cipher, to encrypt the challenge (as indicated by reference numeral 1122) using the PIN to initialize a pseudorandom keystream. Client terminal 550_{N} sends the encrypted challenge as a response message 1126 to the server terminal 550₁.

As indicated by reference numeral 1131 in FIG. 11, the server terminal 550₁ decrypts the response message 1126 using the commonly-utilized PIN to recover the challenge (i.e., the PIN acts as an encryption and decryption “key”). The recovered challenge from the client terminal 550_{N} is compared against the original random number. If a successful match is identified, a confirmation message 1140 is sent from the server terminal 550₁ to the client terminal 550_{N}.

Each of the processes shown in the figures and described in the accompanying text may be implemented in a general, multi-purpose or single purpose processor. Such a processor will execute instructions, either at the assembly, compiled, or machine-level to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and includes a CD-ROM, DVD, magnetic or other optical disc, tape, silicon memory (e.g., removable, non-removable, volatile or non-volatile), packetized or non-packetized wireline or wireless transmission signals.

What is claimed is:

1. A network controller disposed at a headend of a wide area network that provides a service to a plurality of terminals coupled to the wide area network, comprising:
a billing system interface arranged to receive, from a billing system, a household identifier for identifying one or more terminals in the plurality of terminals that are associated with a subscriber account with the service; and
a terminal association identifier server arranged to transmit a terminal association identifier over the wide area network, responsively to the household identifier, to the identified one or more subscriber terminals so that the identified one or more terminals are commonly associated with the subscriber account.

2. The network controller of claim 1 in which the service comprises a home networking service that supports sharing of media content among the identified one or more terminals over the local area network.

3. The network controller of claim 2 in which the home networking service is selected from one of whole home or multi-room DVR.

4. The network controller of claim 2 in which the home networking service is a MoCA (Multimedia over Coax Alliance) networking service.

5. The network controller of claim 1 in which the terminal association identifier is generated by applying a hashing algorithm to the household identifier.

6. The network controller of claim 5 in which the hashing algorithm is selected from one of CRC32, MD5, or SHA-1.

7. The network controller of claim 1 in which the billing system data is used to identify one or more terminals for receiving discrete media content ordered by the subscriber.

8. The network controller of claim 1 in which the wide area network supports an in-band signal path and an out-of-band signal path and the terminal association identifier is carried in the out-of-band signal path as an MSP message.

9. A terminal device, comprising:
one or more processors;
a network interface for receiving a terminal association identifier from a controller over a wide area network; and
a memory for storing a) the terminal association identifier received from the wide area network b) instructions which, when executed by the one or more processors, implement an application, and c) instructions which, when executed by the one or more processors implement an application programming interface for generating, using the terminal association identifier, a unique application identifier that is passed to the application.

10. The terminal device of claim 9 in which the application is arranged for generating, from the unique application identifier, a commonly utilized PIN that enables media content to be securely shared among one or more other terminal devices over a local area network.

11. The terminal device of claim 9 in which the terminal association identifier is not exposed to the application.

12. The terminal device of claim 9 in which the application programming interface is arranged to receive an input parameter from the application, the input parameter being concatenated with the terminal association identifier.

13. The terminal device of claim 12 in which the concatenated input parameter and terminal association identifier are input to a hashing algorithm.

14. The terminal device of claim 9 in which the memory is a hard disk drive that is shared with a DVR.

15. The terminal device of claim 14 in which the network interface is further arranged to receive multimedia content that is selected from one of video, music, pictures, or data, selected portions of the received multimedia content being stored on the DVR.

16. The terminal device of claim 9 in which the application is arranged for providing a user interface to receive a PIN from a user.

17. The terminal device of claim 9 in which the one or more processors, network interface, and memory are substantially incorporated in one of set top box, personal computer, DVR, PVR, whole home DVR, multi-room DVR, or networkable client device.

18. The terminal device of claim 10 in which the other terminal devices are selected from one of set top box, thick client set top box, thin client set top box, personal computer, portable media player, wireless access point, game console, digital media adapter, multimedia server, or audio client.

19. A method for associating terminal devices with a common subscriber account, the method comprising:
identifying a set of one or more terminal devices that are associated with a subscriber account with a media content delivery service;
generating a household identifier to uniquely identify the set of one or more associated terminal devices; and
transmitting the household identifier to a controller disposed on a wide area network to which the one or more associated terminals are coupled.

20. The method of claim 19 in which the method is performed by a business system server that is operatively coupled to the controller.

21. The method of claim 19 in which the household identifier is a household handle comprising a 20 byte field in the Digital Wirelink Protocol.

22. The method of claim 20 in which the business system server is coupled to a business system database, the business system database containing subscriber data including identifying information for at least one of the one or more terminal devices.

23. The method of claim 22 in which the identifying information is selected from one of serial number, ID number, unit address, or MAC address.
